(19) United States
(12) Patent Application Publication
(10) Pub. No.: US 2007/0260757 A1
(43) Pub. Date: Nov. 8, 2007

(54) Command interface for flash device

(76) Inventors: Christopher J. Bueb, Folsom, CA (US); Todd Legler, Shingle Springs, CA (US)

Correspondence Address: KACVINSKY LLC;C/O INTELLEVATE, P.O. BOX 52050, MINNEAPOLIS, MN, 55402, US

(21) Appl. No.: 11/390,935

(22) Filed: Mar. 28, 2006

(51) Int. Cl. G06F 3/00

(52) U.S. Cl. 710/5

(57) ABSTRACT

A system, apparatus, method and article to provide a command interface for flash device are described. The apparatus may include a command interface coupled to a serial input/output path to receive operational code instructions. A parallel interconnect path is coupled to said command interface. The command interface is to determine whether the operational code instruction includes a portal code and to communicate data with a flash module through said parallel interconnect path when the operational code instruction includes the portal code. Other embodiments are described and claimed.

### BACKGROUND

Flash memories are currently available as parallel or serial devices. Most NOR-based flash memory has a full parallel address/data (memory) interface that allows fast random read access to any location. Hence, NOR-based flash is suitable for storage of program code that needs to be infrequently updated, such as computer basic input/output system (BIOS) or firmware in set-top boxes. To reduce pin count, NOR-based flash is also available with a serial interface. Nevertheless, parallel flash devices include a variety of features that are not available in serial flash devices. Accordingly, there may be a need for a serial flash device that can access features of parallel flash devices.

### BRIEF DESCRIPTION OF THE DRAWINGS

FIG. 1 illustrates one embodiment of an apparatus.

FIG. 2 illustrates one embodiment of a serial interface component.

FIG. 3 is a diagram illustrating one embodiment of the operation of a command interface of a serial flash device.

FIG. 4 illustrates one embodiment of a logic flow.

FIG. 5 illustrates one embodiment of a system comprising a serial flash device.

### DETAILED DESCRIPTION

Various embodiments may be generally directed to a command interface for a flash device. The command interface executes parallel flash commands through a serial interface. In this manner, a serial flash device may be implemented using a parallel flash module coupled to the command interface. Such an implementation provides a serial flash device that can access features embedded in a parallel flash module, for example. In addition, the command interface provides modularity. For example, new features added to the parallel flash module will implicitly be available in the serial flash device without modifying the serial flash device interface or interconnects between the serial flash device interface and the parallel flash module. A modular approach provides a way to readily adapt flash devices (serial and/or parallel) to rapidly changing market needs and provides feature enhancements for future flash devices. Accordingly, embodiments comprise decoders and modules to read and interpret operational code (opcode) or sub-opcode (portal code) instructions to define the convention of subsequent bytes following the opcode (e.g., portal code) instruction. The number of required command/data words depends upon the convention of the parallel flash module command. Because parallel flash module command sequences may be a deterministic variation of parallel flash commands, a compiler switch may be derived to allow the conversion of parallel flash source code to serial flash object code. Other embodiments may be described and claimed.

Various embodiments may comprise one or more elements. An element may comprise any structure arranged to perform certain operations. Each element may be implemented as hardware, software, or any combination thereof, as desired for a given set of design parameters or performance constraints. Although an embodiment may be described with a limited number of elements in a certain topology by way of example, the embodiment may include more or less elements in alternate topologies as desired for a given implementation. It is worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

In one embodiment, the apparatus comprises a command interface coupled to a serial input/output path to receive operational code instructions. A parallel interconnect path is coupled to the command interface. The command interface is to determine whether the operational code instruction comprises a portal code and to communicate data with a flash module through the parallel interconnect path when the operational code instruction comprises the portal code.

In one embodiment, a serial interconnect path is coupled to the command interface. The command interface is to communicate the data with the flash module through the serial interconnect path when the operation code instruction does not comprise the portal code.

In one embodiment, the command interface comprises a decoder module coupled to the parallel interconnect path to decode the operational code instruction. An address buffer is coupled to the decoder module and to the parallel interconnect path. When the portal code comprises a read command, the decoder is to load an input data stream following the portal code into the address buffer and to initiate a read operation from the flash module. A data/command buffer is coupled to the decoder module and to the parallel interconnect path. When the portal code comprises a write command, the decoder is to load an input data stream following the portal code into the address buffer and the data/command buffer and to initiate a write operation to the flash module.

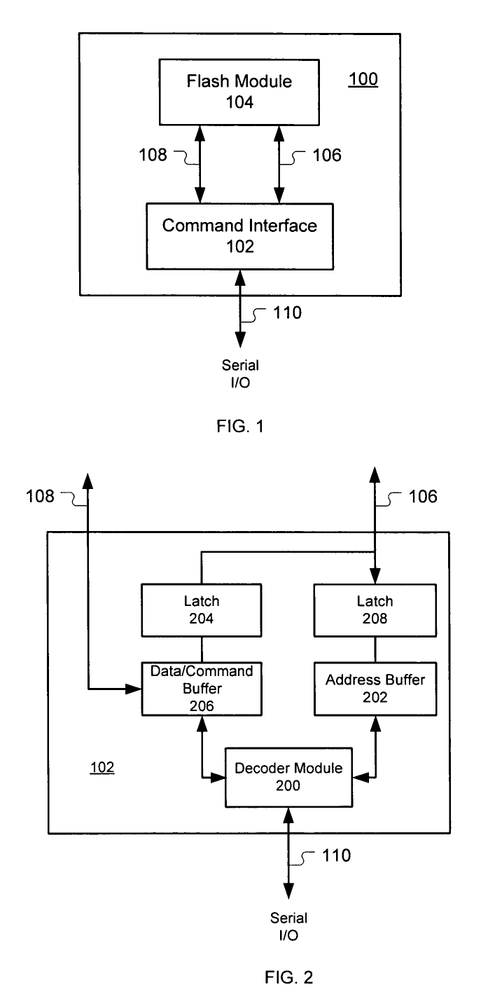

FIG. 1 illustrates one embodiment of an apparatus. FIG. 1 illustrates a block diagram of serial flash device 100. In one embodiment, serial flash device 100 may be implemented as a serial periphery interface (SPI) flash device, although the embodiments described herein should not be limited in this context. As shown in FIG. 1, serial flash device 100 comprises multiple elements, such as command interface 102 coupled to flash module 104 via first parallel interconnect path 106 and second serial interconnect path 108. As used herein, an interconnect path may refer to any circuitry or electrical pathway along which electrical signals (e.g., representing addresses, data, or commands) are sent from one component of flash device 100 to another or to and from flash device 100. The path may comprise one or more electrical conductors arranged in the form of a serial or parallel bus, for example. First parallel interconnect path 106 may be utilized for communicating parallel data or commands with flash module 104. Second serial interconnect path 108 may be utilized for communicating serial data or commands with flash module 104. In one embodiment, serial interconnect path 108 may be an SPI interconnect path 108. In one embodiment, serial flash device 100 receives I/O commands via serial I/O path 110 coupled to command interface 102. In one embodiment, flash module 104 is a parallel flash memory and comprises an address bus and a data bus. The embodiments, however, are not limited to the elements shown in this figure.

In various embodiments, serial flash device 100 may comprise command interface 102. In one embodiment, command interface 102 may be an SPI interface. As used herein, an SPI interface comprises a 4-wire serial communications interface used by many microprocessor peripheral chips, among other logic devices and peripheral circuits. The SPI circuit is a synchronous serial data link that provides support for a low/medium bandwidth (e.g., about 1 Mbaud) network connection amongst central processing units (CPUs) and other devices supporting the SPI. The SPI bus is a relatively simple synchronous serial interface for connecting low speed external devices using a minimal number of wires. For example, the SPI interface standard utilizes synchronous clock shifts serial data into and out of microcontrollers in blocks of 8 bits. Such SPI interfaces are frequently used in handheld and other mobile platform systems, for example. In one embodiment, the SPI bus is a master/slave interface. For example, whenever two devices communicate, one is referred to as the “master” and the other as the “slave” device. The master drives the serial clock. With SPI, data is simultaneously transmitted and received, making it a full-duplexed protocol.

Command interface 102 may comprise a decoder to decode incoming serial commands comprising opcode instructions. Command interface 102 also may comprise one or more buffers to interface with flash module 104. Those skilled in the art will appreciate that opcode instructions may be a portion of a machine language instruction that specifies an operation to be performed (e.g., an instruction). In one embodiment, the computer hardware component in question may a CPU, but may comprise a more specialized module. An opcode instruction may be followed by one or more operands, i.e., what data the operation or instruction should act upon. Operands, upon which opcodes operate, depending on CPU architecture, may comprise use of registers, values in memory, values stored on a stack, I/O ports, address or data bus, and the like. An opcode may specify arithmetic, data copying, logical, and program control operations. In other embodiments, opcodes may be found in byte codes interpreted by a byte code interpreter (or virtual machine). Accordingly, an instruction set architecture may be created to be interpreted by software, rather than a hardware device. Byte code interpreters may operate with higher-level data types and operations than a hardware instruction set.

In one embodiment, command interface 102 may comprise a flash module address buffer, a flash module data/command buffer, among other elements that may be employed to interface with flash module 104. Command interface 102 receives serial formatted commands according to a serial instruction protocol (e.g., SPI protocol) via serial I/O path 110 to read and write information from and to flash module 104. Command interface 102 interprets and converts serial commands to commands compatible with flash module 104. The embodiments, however, are not limited to this example.

In various embodiments, serial flash device 100 may comprise flash module 104 coupled to command interface 102 via first parallel interconnect path 106 and a second serial interconnect path 108. In one embodiment, flash module 104 may be implemented as a parallel flash memory device comprising a parallel address and data bus. Flash module 104 comprises a command user interface comprising an independent set of commands that may not be accessible to a user. Embodiments of command interface 102, however, provide user-level access to these independent set of commands via the command user interface. The embodiments, however, are not limited to this example.

In one embodiment, serial flash device 100 receives commands, such as opcodes, via serial I/O path 110. In one embodiment, these commands may comprise, for example, single-byte opcodes to control operations of serial flash device 100. For example, SPI type serial flash devices employ single-byte opcode instructions. In one embodiment, command interface 102 comprises a decoder module with decode logic (implemented in software, firmware, hardware or any combinations thereof) to read and interpret opcodes and to open a “portal” to the flash module 104 command user interface to provide user-level access to the independent set of commands or device features integrated within flash module 104. The opcode to provide access to the flash module 104 command user interface, and accordingly, to provide user-level access to the independent set of commands, may be referred to herein as a portal opcode instruction, for example. Command interface 102 interprets the incoming opcode and determines whether it is a portal opcode instruction or a serial (e.g., SPI) instruction. Command interface 102 then provides user-level access to flash module 104. For example, if the incoming opcode is a portal opcode instruction, command interface 102 provides user-level access to the independent set of commands within flash module 104.

Flash module 104 may comprise a set of write-only commands to enable writing data in the memory elements of flash module 104. Read operations, to enable reading data from the memory elements of flash module 104, however, may require access to flash module 104 signals, which generally are not accessible through serial flash user interfaces, such as serial I/O path 110. In one embodiment, the portal opcode instruction may be referred to as a second-level opcode instruction, comprising a portal code in the operand. Command interface 102 recognizes the portal opcode instruction and decodes the portal code to interpret incoming read and write commands to flash module 104. Command interface 102 distinguishes between read and write operations to provide read access to flash module 104. The portal opcode instruction also may facilitate compressing input command sequences for flash module 104 commands (i.e., commands that follow the portal instruction). The compressed input sequence makes the input data stream comparable to conventional serial flash commands. When a portal opcode instruction with the subsequent portal code as its operand are received by serial flash device 100, the user can issue flash module 104 commands to enable user-level access to the independent set of commands within flash module 104 via the command user interface.

In various other embodiments, command interface 102 enables the reuse of legacy low-level software instructions, modularizes the serial flash interface (e.g., SPI), and provides higher storage density than conventional flash devices. For example, in one embodiment, command interface 102 may enable higher storage densities than the 128M-bit density limitation of conventional serial flash devices.

In one embodiment, command interface 102 enables the reuse of legacy serial or parallel low-level software instructions. For example, command interface 102 recognizes legacy or conventional parallel flash memory commands or opcodes formed based on serial flash devices. In one embodiment, for example, serial flash device 100 may be implemented with a parallel flash module 104. A compiler switch may be employed to create serial flash object code from parallel flash source code to enable access to parallel flash memory locations through command interface 102 via serial I/O path 110. In one embodiment, the serial object code may provide access to the entire command set of flash module 104. Accordingly, a conventional serial host interface may require only a one-time hardware change to support the portal opcode instructions. Systems designs that support both parallel flash and serial flash also may benefit from a common software base. Various embodiments of command interface 102 may recognize and interpret the portal opcode instructions, reuse legacy low-level software and enable migration to serial flash devices 100 from parallel flash devices.

When serial flash device 100 is enhanced with a new feature, for example, one or more of the available opcodes may be assigned to support the new feature. In conventional implementations, however, each new opcode implemented to support a new device feature would require new decoder circuitry in the conventional serial flash interface. The added decoder circuitry incrementally increases the complexity of the conventional serial flash interface. As the serial flash interface becomes increasingly complex, it becomes more and more difficult to integrate with conventional parallel flash modules. As a result, the conventional serial flash interface design becomes less portable. In addition, because there are no standards for opcode assignment in conventional serial flash interfaces, there may be incompatibility between opcodes among various conventional serial flash devices. Although, opcode compatibility may be adequate when serial flash designs are duplicated, the opcodes become incompatible when serial flash devices are developed separately and comprise different features.

Accordingly, in one embodiment, command interface 102 of serial flash device 100 may be modularized. For example, a conventional serial flash protocol (e.g., SPI), which includes common opcodes for standard functions, may be employed to communicate with serial flash device 100. Thus, in one embodiment, command interface 102 may comprise additional opcodes to provide access to features within flash module 104 as previously discussed. Furthermore, as additional features are integrated into flash module 104, they become accessible through command interface 102 via opcode interpretation. Accordingly, there is no need to continually increase the complexity of command interface 102 as new features are introduced in flash module 104. The addition of the portal opcode instruction feature followed by a portal code in the operand makes command interface 102 portable to different flash module 104 designs.

In addition, in one embodiment, serial interface 120 may enable increased flash memory density. For example, in one embodiment, command interface 102 may extend memory density beyond conventional density limits of 128M-bit. For example, a conventional serial instruction protocol may be limited to a 24-bit wide address with each of the 2²⁴ addresses corresponding to a single byte of data. To extend beyond a memory density of 128M-bit, additional address bits may be required. This would employ an extended serial instruction protocol. In one embodiment, however, command interface 102 with the portal opcode instruction may be employed to extend the serial instruction protocol to comprise an instruction sequence that is consistent with legacy parallel flash commands. This may provide a seamless density migration between low density devices and high density devices and thus, for example, may extend the memory density beyond conventional 128M-bit density.

FIG. 2 illustrates one embodiment of a serial interface component. FIG. 2 illustrates a block diagram of command interface 102. As shown in FIG. 2, command interface 102 comprises multiple elements, such as a portal opcode instruction decoder module to interpret the portal code following the portal opcode instruction. For example, in one embodiment, command interface 102 may comprise decoder module 200 coupled to serial I/O path 110. In one embodiment, decoder module 200 is decodes all incoming opcode instructions. Command interface 102 also may comprise flash module address buffer 202 coupled to decoder module 200. Address buffer 202 comprises a serial input port and parallel output ports. Flash module address buffer 202 also is coupled to latch 204, which is coupled to the address bus of flash module 104 via parallel interconnect path 106. Latch 204 may comprise multiple latches connected in parallel depending on the bit-width of the address portion of first parallel interconnect path 106. Command interface 102 also comprises a flash module data/command buffer 206 coupled to decoder module 200. Data and commands are referred to as data, for example. Flash module data/command buffer 206 comprises a serial input port and parallel output ports. Flash module data/command buffer 206 also is coupled to latch 208, which is coupled to the data/command bus of flash module 104 via second serial interconnect path 108. Latch 208 may comprise multiple latches connected in parallel depending on the bit-width of the data/command bus portion of first parallel interconnect path 106. Decoder module 200 also is coupled to serial interconnect path 108 for processing serial data or commands. The embodiments, however, are not limited to the elements shown in this figure.

In one embodiment, command interface 102 comprises decoder module 200 to decode the portal opcode instruction and portal code operand without altering the functionality of flash module 104. In various embodiments, command interface 102 may be adapted to interpret incoming opcode instructions either as portal opcode instructions or as an ordinary serial commands and to execute appropriate operations accordingly. Portal opcode instructions may comprise, for example, read and write operations intended for flash module 104 and to access additional user-level features embedded in flash module 104. For example, to access the user-level independent set of commands through the command user interface. Accordingly, when an opcode instruction is received decoder module 200 determines whether it is a portal opcode instruction. When a portal opcode instruction is received, decoder module 200 determines whether the operand following the portal opcode instruction comprises a portal code. A portal code may be used to indicate a parallel read/write command or a conventional serial read/write command for flash module 104.

When command interface 102 receives a portal opcode instruction, decoder module 200 interprets the subsequent operand as a portal code to indicate a parallel read operation, parallel write operation or a conventional serial read/write operation. Decoder module 200 is activated to interpret the portal code operand following the portal opcode instruction. Accordingly, when decoder module 200 detects a read operation in the portal code, command interface 102 loads the subsequent input data stream following the portal code into the flash module address buffer 202. When flash module address buffer 202 is loaded, latches 204 latch the address onto the address bus of flash module 104 via first parallel interconnect path 106. Flash module 104 then initiates a read operation. When command interface 102 receives a portal code comprising a write operation, decoder module 200 interprets the write operation and loads the subsequent input data stream into flash module address buffer 202 and flash module data/command buffer 206. When flash module address buffer 202 and flash module data/command buffer 206 are loaded, latches 208 latch the address and data/commands (i.e., data and commands are used synonymously) into respective address and data/command buses of flash module 104 via first parallel interconnect path 106. Accordingly, flash module 104 initiates a write operation. Further, serial interface decode module 200 also decodes conventional serial commands. Accordingly, when command interface 102 decoder module 200 interprets an ordinary serial command (e.g., SPI protocol command), decoder module 200 does not activate the read/write buffer operations discussed above and initiates address and data/command transfers from data/command buffer 206 to flash module 104 through second serial interconnect path 108.

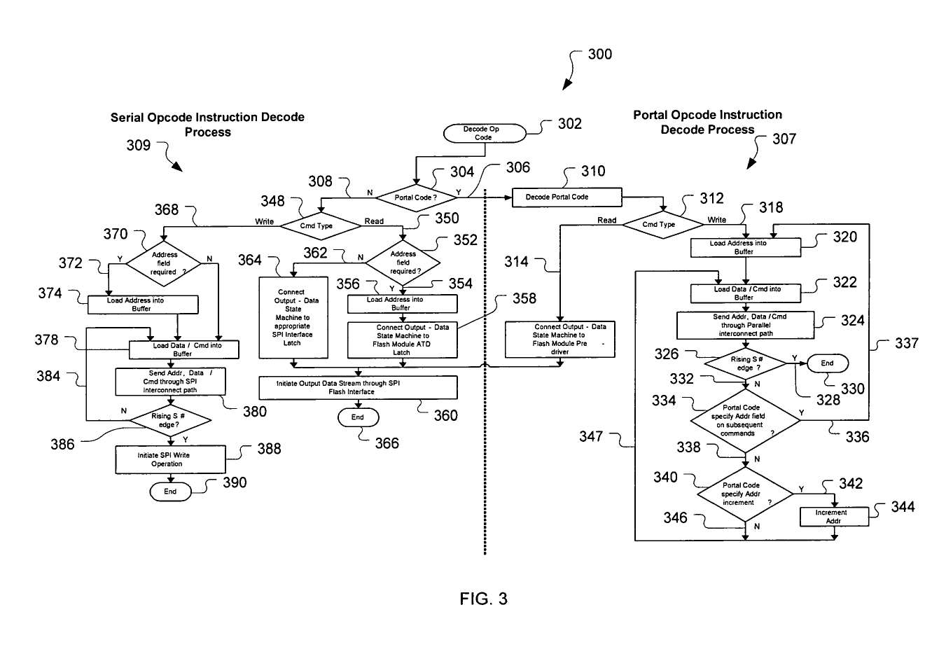

FIG. 3 is a diagram illustrating one embodiment of the operation of a command interface of a serial flash device. Diagram 300 illustrates one embodiment of the operation of command interface 102 of serial flash device 100. In one embodiment, command interface 102 receives serial opcode instructions, which may comprise portal opcode instructions. Decode module 200 is adapted to interpret the serial opcode instructions and portal opcode instructions and to execute the appropriate operations according to diagram 300. Accordingly, command interface 102 receives an incoming serial opcode instruction via serial I/O path 110. Decoder module 200 decodes (302) the incoming serial opcode instruction. Decoder module 200 determines (304) whether the opcode instruction is a portal opcode instruction or a legacy serial opcode instruction. If the opcode instruction is a portal opcode instruction, processing continues along “yes” branch (306) to portal opcode instruction decode process (307). If the opcode instruction is not a portal opcode instruction, but rather is a legacy serial opcode instruction, processing proceeds along “no” branch (308) to legacy serial opcode instruction decode process (309).

The process to decode a portal opcode instruction along “yes” branch (306) is described first. Accordingly, decoder module 200 decodes (310) the portal code operand of the portal opcode instruction. In this mode, decoder module 200 emulates functions within the flash module 104. Decoder module 200 then determines (312) whether the portal code is a “read” command or a “write” command. If the portal code is a “read” command, processing continues along “read” branch (314) and connects (316) the output-data state machine of flash device 100 to flash module 104 pre-driver. Processing then proceeds to legacy serial command decode and initiates (360) an output data stream through command interface 102 and serial I/O path 110.

If the portal code is a “write” command, processing proceeds along “write” branch (318). Accordingly, decoder module 200 loads (320) the write-to address into flash module 104 address buffer 202. The data/command at the address is then loaded (322) into data/command buffer 206. In the illustrated embodiment, data and commands are treated synonymously by decoder module 200. The data/command is sent (324) through parallel interconnect path 106. If a rising S# edge stop command sequence is detected (326), the process proceeds along “yes” branch 328 and execution ends (330). If a rising S# edge stop command sequence is not detected (326), the process continues along “no” branch (332) and determines (334) whether the portal code specifies an address field in subsequent commands. If the portal code does specify an address field in subsequent commands, then the process loops (337) back along “yes” branch (336) and loads (320) the address into address buffer 202. The process continues or loops between blocks (320) and (334) until the portal code no longer specifies an address field in the subsequent command. The process then proceeds along “no” branch (338) and determines (340) whether the portal code specifies an address increment instruction. If the portal code does specify an address increment instruction, the process continues along “yes” branch (342) and increments (344) the address. Otherwise, the process continues along “no” branch (346) and loops (347) back to load (322) the data/command into data/command buffer 206 from the incremented address. The process continues to loop from block (322).

As previously discussed, if the incoming opcode is not a portal code and is a legacy serial command, processing proceeds along “no” branch (308) to the legacy serial command decode process (309). Decoder module 200 determines (348) whether the command is a “read” or “write” command. If the command is a “read” command, the process continues along “read” branch (350) and determines (352) whether an address field is required. If an address field is required, the process continues along “yes” branch (354), loads (356) the address into flash module 104 address buffer 202, connects (358) the output-data state machine of flash device 100 to latch 204, initiates (360) an output data stream through command interface 102, and the process ends (366). In one embodiment, memory may use address transition detection (ATD). If no address field is required at decision block (352), the process continues along “no” branch (362) to connect (364) the output-data state machine to the appropriate command interface 102 latch 204 or 208. Accordingly, the process initiates (360) an output data stream through command interface 102.

If, at decision block (348), the command is a “write” command, the process continues along “write” branch (368) to determine (370) if an address field is required for the “write” operation. If an address is required for the “write” operation, the process continues along “yes” branch (372) and loads (374) the address into flash module 104 write address buffer 202. If no address is required for the “write” operation, the process proceeds along “no” branch (376). In either case, the process loads (378) the data/command into data/command buffer 206 and sends (380) the address for the data/command through serial interconnect path 108. The process determines (382) if a rising S# edge occurred. If not, the process continues along “no” branch (384) and continues to load (378) the data/command into data/command buffer 206 and sends (380) the address for the data/command through serial interconnect path 108. If the rising S# edge occurred, the process continues along “yes” branch (386) and initiates (388) a serial write operation and the process ends (390).

Operations for the above embodiments may be further described with reference to the following figures and accompanying examples. Some of the figures may include a logic flow. Although such figures presented herein may include a particular logic flow, it can be appreciated that the logic flow merely provides an example of how the general functionality as described herein can be implemented. Further, the given logic flow does not necessarily have to be executed in the order presented unless otherwise indicated. In addition, the given logic flow may be implemented by a hardware element, a software element executed by a processor, or any combination thereof. The embodiments are not limited in this context.

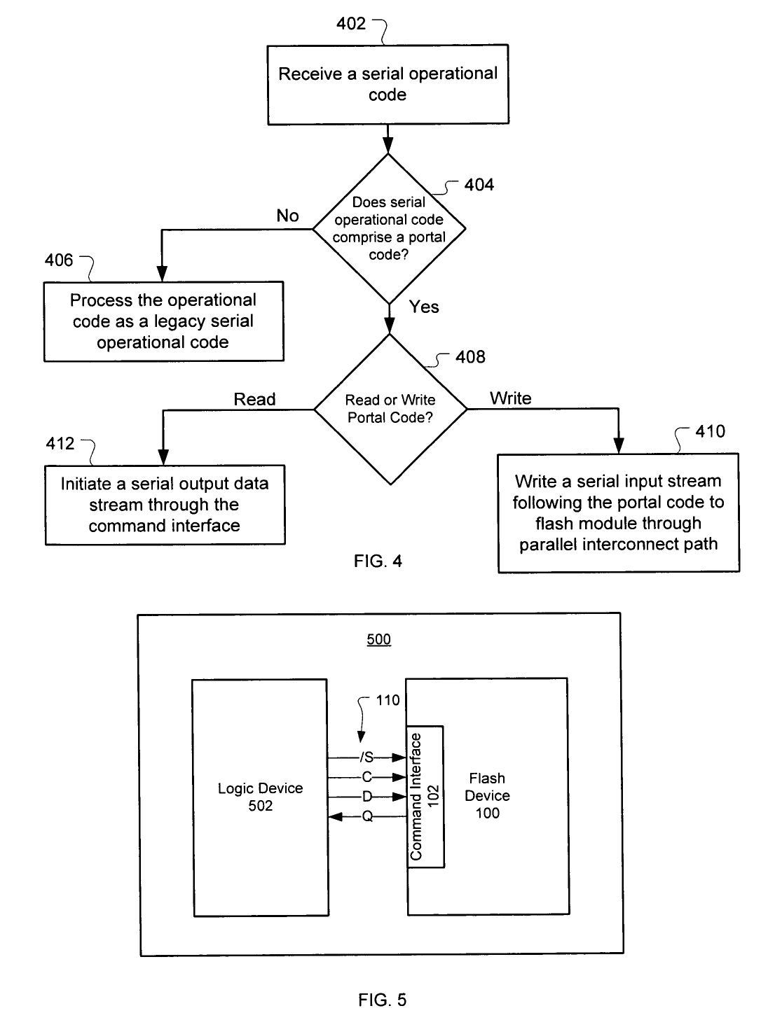

FIG. 4 illustrates one embodiment of a logic flow. FIG. 4 illustrates a logic flow 400. Logic flow 400 may be representative of the operations executed by one or more embodiments described herein. As shown in logic flow 400, command interface 102 receives (402) a serial operational code. Command interface 102 determines (404) whether the serial operational code comprises a portal code. If there is no portal code, command interface 120 processes (406) the operational code as a legacy serial operational code. If the serial operational code comprises a portal code, command interface 102 determines (408) whether it is a write or a read command. When the portal code comprises a write command, the command module 102 writes (410) a serial input stream following the portal code to flash module 104 through parallel interconnect path 106. The serial input stream comprises an address to write to in the flash module 104 and data to write in the address of the flash module 104. When the portal code comprises a read command, command interface 102 initiates (412) a serial output data stream through the command interface 102.

In one embodiment, the command interface 102 loads address buffer 204 with the address, address buffer 204 comprises a serial input port and a parallel output port. In one embodiment, command interface 102 loads data buffer 206 with the data. Data buffer 206 comprises a serial input port and a parallel output port. The data is written to the address in flash module 104. In one embodiment, command interface 102 writes a serial input stream to flash module 104 through serial interconnect path 108 when the operational code does not comprise a portal code.

FIG. 5 illustrates one embodiment of a system comprising a serial flash device. FIG. 5 illustrates a block diagram of system 500 comprising serial flash device 100. System 500 may be representative of a system or architecture suitable for use with one or more embodiments described herein, such as serial flash device 100, interface 102, diagram 300, logic flow 400, and so forth.

As shown in FIG. 5 system 500 comprises a logic device 502 coupled to serial flash device 100 comprising command interface 102. System 500 may comprises or may form a portion of a digital video disk (DVD) (or digital versatile disk) drive, compact disk (CD) drive, digital radio, digital subscriber line (DSL) and/or cable modems, MP3 (moving pictures expert group audio layer-3) players, wireless local area networks (LAN), liquid crystal display (LCD) monitors, printers, networking, hard disk drives, set-top box, personal computer (PC) basic input/output system (BIOS), DVD recorders, industrial field programmable gate arrays (FPGAs), programmable logic device (PLD), global positioning system (GPS), digital signal processors (DSPs), cellular telephone, personal digital assistant (PDA), smart-phone, among other systems, devices, and/or components.

Logic device 502 may be a processor, DSP, FPGA, baseband processor, PLD, and any data processing device that may be used to implement any of the systems 500 discussed herein comprising serial I/O 110 and command interface 102. Logic device 502 may be coupled to serial flash device 100 through serial I/O path 110 and command interface 102. Accordingly, logic device 502 serially interfaces with flash device 100 via serial I/O path 110. In one embodiment, serial I/O path 110 may comprise four lines: a chip select (/S), a serial clock (C), a serial data in (D), and a serial data out (Q) lines.

In various embodiments, system 500 may be implemented as a wireless system, a wired system, or a combination of both. When implemented as a wireless system, system 500 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 500 may include components and interfaces suitable for communicating over wired communications media, such as I/O adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

In various embodiments, system 500 may include serial flash device 100 and may connect to other devices over one or more communication media. System 500 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), PLDs, DSPs, FPGAs, logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

In various implementations, system 500 may be illustrated and described as comprising several separate functional elements, such as modules and/or blocks. Although certain modules and/or blocks may be described by way of example, it can be appreciated that a greater or lesser number of modules and/or blocks may be used and still fall within the scope of the embodiments. Further, although various embodiments may be described in terms of modules and/or blocks to facilitate description, such modules and/or blocks may be implemented by one or more hardware components (e.g., processors, DSPs, PLDs, FPGAs, ASICs, circuits, registers), software components (e.g., programs, subroutines, logic) and/or combination thereof.

In various embodiments, system 500 may comprise multiple modules connected by one or more communications media. Communications media generally may comprise any medium capable of carrying information signals. For example, communications media may comprise wired communications media, wireless communications media, or a combination of both, as desired for a given implementation. Examples of wired communications media may include a wire, cable, PCB, backplane, semiconductor material, twisted-pair wire, co-axial cable, fiber optics, and so forth. An example of a wireless communications media may include portions of a wireless spectrum, such as the radio-frequency (RF) spectrum. The embodiments are not limited in this context.

The modules may comprise, or be implemented as, one or more systems, sub-systems, devices, components, circuits, logic, programs, or any combination thereof, as desired for a given set of design or performance constraints. For example, the modules may comprise electronic elements fabricated on a substrate. In various implementations, the electronic elements may be fabricated using silicon-based IC processes such as complementary metal oxide semiconductor (CMOS), bipolar, and bipolar CMOS (BiCMOS) processes, for example. The embodiments are not limited in this context.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An apparatus, comprising:
a command interface coupled to a serial input/output path to receive operational code instructions; and
a parallel interconnect path coupled to said command interface;
wherein said command interface is to determine whether said operational code instruction comprises a portal code and to communicate data with a flash module through said parallel interconnect path when said operational code instruction comprises said portal code.

2. The apparatus of claim 1, comprising:
a serial interconnect path coupled to said command interface;
wherein said command interface is to communicate said data with said flash module through said serial interconnect path when said operation code instruction does not comprise said portal code.

3. The apparatus of claim 1, wherein said command interface comprises a decoder module coupled to said parallel interconnect path to decode said operational code instruction.

4. The apparatus of claim 3, comprising an address buffer coupled to said decoder module and to said parallel interconnect path; wherein when said portal code comprises a read command, said decoder is to load an input data stream following said portal code into said address buffer and to initiate a read operation from said flash module.

5. The apparatus of claim 4, comprising a data/command buffer coupled to said decoder module and to said parallel interconnect path; wherein when said portal code comprises a write command, said decoder is to load an input data stream following said portal code into said address buffer and said data/command buffer and to initiate a write operation to said flash module.

6. A system, comprising:
a programmable logic device; and
a flash device coupled to said programmable logic device;
wherein said flash device comprises a command interface coupled to a serial input/output path to receive operational code instructions; and a parallel interconnect path coupled to said command interface; wherein said command interface is to determine whether said operational code instruction comprises a portal code and to communicate data with a flash module through said parallel interconnect path when said operational code instruction comprises said portal code.

7. The system of claim 6, comprising:
a serial interconnect path coupled to said command interface;
wherein said command interface is to communicate said data with said flash module through said serial interconnect path when said operation code instruction does not comprise said portal code.

8. The system of claim 6, wherein said command interface comprises a decoder module coupled to said parallel interconnect path to decode said operational code instruction.

9. The system of claim 8, comprising an address buffer coupled to said decoder module and to said parallel interconnect path; wherein when said portal code comprises a read command, said decoder is to load an input data stream following said portal code into said address buffer and to initiate a read operation from said flash module.

10. The system of claim 9, comprising a data/command buffer coupled to said decoder module and to said parallel interconnect path; wherein when said portal code comprises a write command, said decoder is to load an input data stream following said portal code into said address buffer and said data/command buffer and to initiate a write operation to said flash module.

11. A method, comprising:
receiving a serial operational code at a command interface;
determining whether said serial operational code comprises a portal code;
writing a serial input stream following said portal code to a flash module through a parallel interconnect path when said portal code comprises a write command, said serial input stream comprising an address to write to in said flash module and data to write in said address of said flash module; and
initiating a serial output data stream through said command interface when said portal code comprises a read command.

12. The method of claim 11, comprising:
loading an address buffer with said address, said address buffer comprising a serial input port and a parallel output port.

13. The method of claim 12, comprising:
loading a data buffer with said data, said data buffer comprising a serial input port and a parallel output port; and
writing said data to said address in said flash module.

14. The method of claim 11, comprising:
writing a serial input stream to said flash module through a serial interconnect path when said operational code does not comprise a portal code.

15. An article comprising a machine-readable storage medium containing instructions that if executed enable a system to receive a serial operational code at a command interface; determine whether said serial operational code comprises a portal code; write a serial input stream following said portal code to a flash module through a parallel interconnect path when said portal code comprises a write command, said serial input stream comprising an address to write to in said flash module and data to write in said address of said flash module; and initiate a serial output data stream through said command interface when said portal code comprises a read command.

16. The article of claim 15, further comprising instructions that if executed enable the system to load an address buffer with said address, said address buffer comprising a serial input and a parallel output.

17. The article of claim 16, further comprising instructions that if executed enable the system to load a data buffer with said data, said data buffer comprising a serial input and a parallel output; and write said data to said address in said flash module.

18. The article of claim 15, further comprising instructions that if executed enable the system to write a serial input stream to said flash module through a serial interconnect path when said operational code does not comprises a portal code.
